(19) United States
(12) Patent Application Publication
(10) Pub. No.: US 2018/0061282 A1
(43) Pub. Date: Mar. 1, 2018

(54) Automotive Identification Tag System

(71) Applicant: Paul Vincent Engle, JR., Franklinville, NJ (US)

(72) Inventor: Paul Vincent Engle, JR., Franklinville, NJ (US)

(21) Appl. No.: 15/253,675

(22) Filed: Aug. 31, 2016

(51) Int. Cl. G09F 3/08; G09F 21/04; G09F 3/00

(52) U.S. Cl. CPC G09F 3/08; G09F 3/0297; G09F 3/0288; G09F 21/04

(57) ABSTRACT

The automotive industry is growing rapidly and requires a more effective system to manage customer vehicles within automotive organizations. The automotive identification tag system utilizes the vital elements of tracking a customer's vehicle and information in a simple and effective manner. The tag system is to serve the purpose of coordinating an assigned reference designation to a vehicle with number(s), letter(s) or symbol(s) in a corresponding sequence to identify the specified vehicle through the inclusive tag system. The inclusive tag has detachable elements that consist of multiple elements such as mirror tag, key tag and claim check tag. The mirror tag is a highly visible element to be displayed on a vehicle's rear view mirror. The key tag requires attachment to a key ring. The claim tag is for the customer tracking purposes. Each specified tag is detachable by means of perforations along each boarding tag.

### BACKGROUND OF THE INVENTION

The automotive industry is growing rapidly and requires a more effective system in which to manage customer vehicles within automotive organizations. The system utilizes the vital elements of tracking a customer's vehicle in a simple manner. The automotive end user of this system has the option to utilize more detailed descriptions if desired.

### BRIEF SUMMARY OF THE INVENTION

The purpose of the automotive identification tag is for the management of customer vehicles for an automotive service oriented business. Automotive oriented businesses include but are not limited to dealerships, repair shops, body shops, clean/detail and performance shops. The tag is to serve the purpose of coordinating an assigned reference designation to a vehicle with corresponding number(s), letter(s) or symbol(s) in a corresponding sequence to identify the specified vehicle through the inclusive automotive identification system.

### BRIEF DESCRIPTION OF THE DRAWINGS

FIG. 1 is a front view of the automotive identification tag system;

FIG. 2 is the back view of the automotive identification tag system;

### DETAILED DESCRIPTION OF THE INVENTION

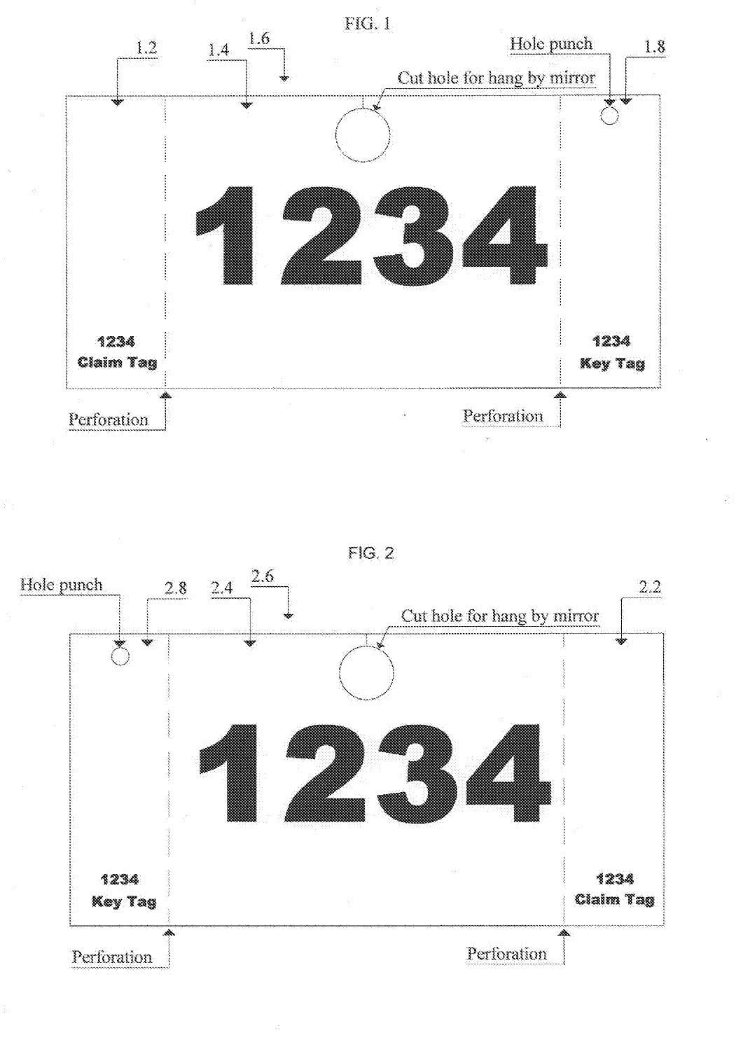

This inclusive tag has detachable elements that consists of multiple elements such as a mirror tag FIG. 1 (1.4) and FIG. 2 (2.4), key tag FIG. 1 (1.8) and FIG. 2 (2.8) and claim check tag FIG. 1 (1.2) and FIG. 2 (2.2). The inclusive tag FIG. 1 (1.6) and FIG. 2 (2.6) has perforations to detach each individual tag.

The mirror tag FIG. 1 (1.4) and FIG. 2 (2.4) is part of the detachable inclusive tag. It is larger than the other associated tags that has larger corresponding number(s), letter(s) or symbol(s) with a cut/hole or opening that has the ability to hang by a vehicle's rearview mirror for the ease of visibility.

The key tag FIG. 1 (1.8) and FIG. 2 (2.8) is part of the detachable element that is smaller than the mirror tag. The key tag has corresponding number(s), letter(s) or symbol(s) which has a purpose to attach to a vehicle's key(s) to manage the designated identification for vehicle management. The key tag has a hole-punch to attach to a key ring. The key tag can also be attached by using an accessory item such as wire tag.

The claim check tag FIG. 1 (1.2) and FIG. 2 (2.2) is part of the detachable element that is smaller than the vehicle's mirror tag. It has corresponding number(s), letter(s) or symbol(s) which is given to a customer to manage the designated identification for vehicle management.

The tag system has a combination of the management elements included such as the mirror tag, key tag or claim check tag. This inclusive tag is configured in any desired configuration within FIG. 1 (1.6) and FIG. 2 (2.6) with perforations to separate each individual tag. The individual tags have specified information that can provide more descriptive information for the automotive service oriented business that includes a work order number, repair order number, customer name(s), comments, year/make/model/color/description of vehicle. The additional information that can be included on this tag management system is not limited to any description to better identify the vehicle and provide useful information that can better organize a vehicle's service oriented business. This tag system can be organized in different orientations within the entirety of the complete tag when printed for the specific automotive oriented business or at the discrepancy of the printer and/or manufacturing company. The tags within their entirely may be organized in a manner that is in ascending or descending order. The tags within their entirety can be bound in a book like manner using an adhesive on an edge to have “packs” that consist of specified quantities. The packs can be in such multiples of 25, 50, 100 or any desired quantity. The tags can be available in any desired shape, color or size that would be at the discretion of the automotive service oriented business. The automotive tag system can be single sided or double sided. The font size(s)/style(s)/color(s) would be at the discretion of the automotive service oriented business and/or the printer/manufacturing company. The tags can be manufactured with a paper product or with any variation of a synthetic or non-synthetic material. The material can be manufactured from a recycled material. The material can vary in thickness which may result in the flexibility variations depending on the material used. The tag system can have a printed bar code/printed scan code to be integrated into a computerized management system. The printed bar code/printed scan code will identify the specific assigned reference designation with each inclusive tag which is optional with the tag system and its associated elements which includes the mirror tag, key tag and claim check tag. The bar code/scan code computerized management system is a separate entity and is not included within the parameters of the tag system.

FIG. 1 and FIG. 2 Drawings:

FIG. 1 (Front view of tag) and FIG. 2 (Back view of tag) are similar in reference of the common elements that are identical between the (FIG. 1) front view of tag and (FIG. 2) back view of the tag. The common elements that are identical include the entire automotive identification tag with all designated elements described within FIG. 1 (1.6) and FIG. 2 (2.6), mirror tag FIG. 1 (1.4) and FIG. 2 (2.4), key tag FIG. 1 (1.8) and FIG. 2 (2.8), claim check tag FIG. 1 (1.2) and FIG. 2 (2.2). Both (FIG. 1) front view of tag and (FIG. 2) back views of the tag utilize the exact same corresponding designations which include number(s), letter(s) or symbol(s). The (FIG. 1) front view of tag and (FIG. 2) back view of the tag generally remain with identical elements. Some elements may vary in font, color, size or customized content at the discretion of the automotive service oriented business and/or printer/manufacturer. Both (FIG. 1) front view of the tag and (FIG. 2) back view of the tag indicate precise perforations which are created during the manufacturing/printing process to utilize the detachable elements of the automotive identification tag system which are identified as the key tag FIG. 1 (1.8) and FIG. 2 (2.8) and the claim check tag FIG. 1 (1.2) and FIG. 2 (2.2). The mirror tag FIG. 1 (1.4) and FIG. 2 (2.4) will then display as an individual element once the key tag and the claim check tag are detached. The mirror tag FIG. 1 (1.4) and FIG. 2 (2.4) will always have the center cut at the top of the tag with a cut/slice to hang the tag from a rear view mirror in a motor vehicle if desired. The key tag FIG. 1 (1.8) and FIG. 2 (2.8) will always have a hole punch(optional feature) no matter (FIG. 1) front view of the tag or (FIG. 2) back view of the tag.

FIG. 1: (Front View) The purpose of the (FIG. 1) front view of the automotive identification tag is to display one of the two sided automotive identification tag. The (FIG. 1) front view is only a designation to distinguish between the two sided tag due to the front and back views will utilize identical elements at the discretion of the automotive service oriented business and/or printer/manufacturing company.

FIG. 2: (Back View) The purpose of the (FIG. 2) back view of the automotive identification tag is to display one of the two sided automotive identification tag. The back view is only a designation to distinguish between the two sided tag due to the (FIG. 1) front and (FIG. 2) back views will utilize identical elements at the discretion of the automotive service oriented business and/or printer/manufacturing company.

1) The automotive identification tag system has a combination of management elements included such as the mirror tag with an attached key tag and claim check tag, the mirror tag is a highly visible element to be displayed by hanging on a vehicle's rear view mirror, the key tag requires attachment to a key ring or can be attached by using an accessory item such as wire tag, the claim tag is for the customer tracking purposes, each specified tag within the inclusive tag system is detachable by means of perforations along each boarding tag.

2) The individual tags can have specified information that can provide more descriptive information include a work order number, repair order number, customer name, comments, year/make/model/color, description of vehicle, and it can be organized in different orientations within the entirety of the complete tag when printed for the specific automotive service oriented business or at the discrepancy of the printing/manufacturing company/end user.

3) The tag system can be specified shape(s), color(s) or size(s) that would be at the discretion of the automotive service oriented business and/or printing/manufacturing company/end user, and can be single sided or double sided, The tag system can have a bar code/printed scan code to be integrated into a computerized management system.
